(19) United States
(12) Patent Application Publication
(10) Pub. No.: US 2025/0258106 A1
(43) Pub. Date: Aug. 14, 2025

(54) Surface Inspection Apparatus and Method

(71) Applicant: ABB Schweiz AG, Baden (CH)

(72) Inventor: Víctor Álvarez, Sant Just Desvern (ES)

(73) Assignee: ABB Schweiz AG, Baden (CH)

(21) Appl. No.: 19/194,339

(22) Filed: Apr. 30, 2025

Related U.S. Application Data
(63) Continuation of application No. PCT/EP2022/080588, filed on Nov. 2, 2022.

(51) Int. Cl. G01N 21/88; G01N 21/95

(52) U.S. Cl. CPC G01N 21/8806; G01N 21/9515

(57) ABSTRACT

A surface inspection apparatus comprises a camera, an actuator apparatus for displacing the camera relative to a surface to be inspected; a first light source mounted to the actuator apparatus for joint displacement with the camera; and a second light source arranged so that an angle in which optical axes of the first and second light sources intersect is non-zero.

### CROSS-REFERENCE TO RELATED APPLICATIONS

The instant application claims priority to International Patent Application No. PCT/EP2022/080588, filed Nov. 2, 2022, which is incorporated herein in its entirety by reference.

### FIELD OF THE DISCLOSURE

The present disclosure generally relates to an apparatus and a method for surface inspection and, more particularly, to a method for finding possible defects in a recently applied paint layer.

### BACKGROUND OF THE INVENTION

Quality inspection of a painted or otherwise finished surface of a workpiece such as, for example, a car bumper is conventionally carried out by a worker taking up each recently finished workpiece and watching out for irregularities that might show up when looking at the workpiece from different angles. Depending on the worker's attention, defects may go unnoticed. With the naked eye, the worker cannot measure precisely the size of a defect and cannot judge reliably whether a workpiece under examination meets a customer's quality standards. In order to avoid possible customer's complaints, the worker is therefore likely to have every workpiece touched up in which he finds a defect, regardless of its size, thus causing unnecessary costs. Still, all this effort cannot exclude possible customer complaints due to a defect that has been overlooked.

DE 10 2015 106 777 A1 discloses an apparatus for surface inspection of workpieces having undergone industrial cleaning. The apparatus comprises a robot arm, a camera which is mounted on the robot arm so that it can be moved with respect to a surface to be inspected, and an image processing unit for evaluating images taken by the camera. When the apparatus relies on ambient light, it is evident that the reliability of inspection results depends critically on illumination quality. But even when reproducible lighting conditions are provided, it is difficult for the image processing unit to distinguish between a finishing defect and a shading which is due to unevenness of the surface under inspection. The prior art also considers associating a light source to the camera. By moving the robot arm, the surface can thus be illuminated from different directions, but since the perspective of the camera varies, too, differences in shading that would result from changing the direction are still difficult to evaluate. Moreover, if the surface has to be examined from different perspectives, the time spent on an examination will increase greatly.

### BRIEF SUMMARY OF THE INVENTION

The present disclosure generally describes a surface inspection apparatus and method, which allow for quick and reliable detection of finishing defects in a surface.

In one embodiment, the disclosure describes a surface inspection apparatus comprising a) a camera; b) an actuator apparatus for displacing the camera relative to a surface to be inspected; c) a first light source mounted to the actuator apparatus for joint displacement with the camera; wherein the apparatus further comprises d) a second light source arranged so that an angle in which optical axes of the first and second light sources intersect is non-zero.

### BRIEF DESCRIPTION OF THE SEVERAL VIEWS OF THE DRAWING(S)

FIG. 1 is a diagram of a robotic system implementing the invention.

FIG. 2 is a diagram of the end effector of the robotic system of FIG. 1.

FIG. 3 is a diagram of a process of scanning for defects using the apparatus in accordance with the disclosure.

FIG. 4 is another diagram of a process of scanning for defects using the apparatus in accordance with the disclosure.

### DETAILED DESCRIPTION OF THE INVENTION

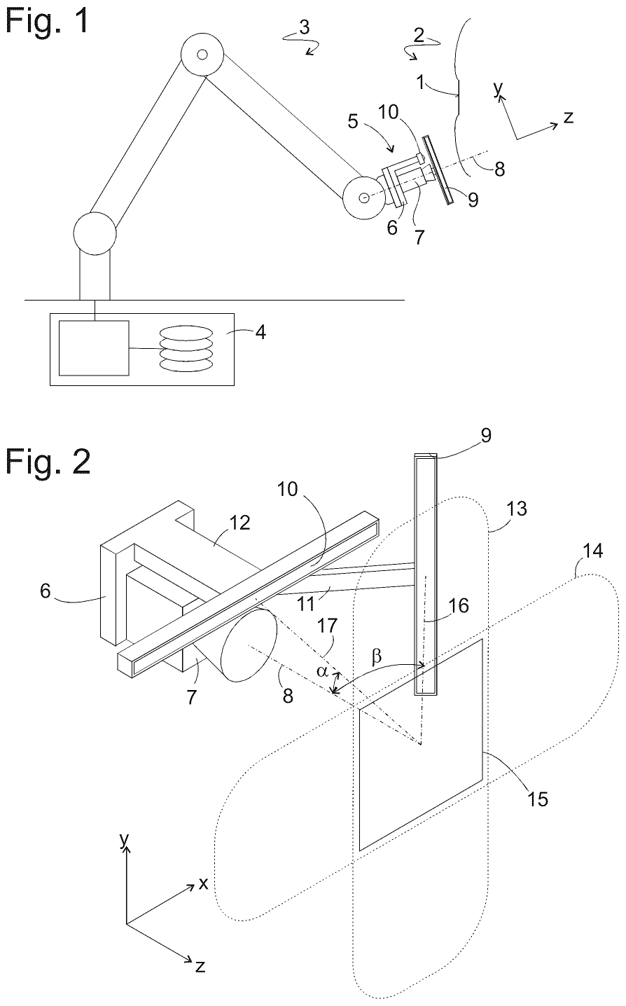

FIG. 1 is a schematic view of a surface inspection apparatus according to the present invention and of a workpiece 2 having a surface 1 to be inspected, e.g. the outside of a freshly painted car bumper, shown in cross section here. The surface inspection apparatus comprises a robot arm 3, a controller 4 associated to it, and an inspection assembly 5 mounted on a distal flange of the robot arm 3.

The controller 4 comprises a processor 18 and a storage 19 in which a three-dimensional model of the workpiece 2, e.g. CAD data used for its manufacture, is stored, based on which the processor 18 can control the robot arm 3 to move the camera 7 along the surface 1 maintaining a predetermined distance, so as to scan the entire surface 1.

The inspection assembly 5, shown in more detail in FIG. 2, comprises a backplane 6 facing the distal flange, an electronic camera 7 which is mounted on the backplane 6 and has an optical axis 8, and two light sources 9, 10, each of which is mounted on an arm 11, 12 extending from the backplane 6. The light sources 9, 10 are elongate in directions that are orthogonal to each other and to the optical axis 8. In the view shown in FIG. 1, the direction of elongation y of light source 9 is parallel to the paper plane, whereas that of light source 10 is perpendicular to it.

Each light source 9, 10 comprises a plurality of LEDs distributed along its direction of elongation, and, when the inspection assembly 5 faces the surface 1, illuminates an elongate strip 13, 14, respectively, on the surface 1. A field of view 15 of the camera 7 is located at the intersection of the two strips 13. 14, so that each point in the field of view 15 can be illuminated by either of the two light sources 9, 10.

Each light source 9, 10 can be assigned an optical axis 16, 17. This optical axis can e.g. be a symmetry axis of the light emission from the light source, or, if the light is not distributed symmetrically, a direction corresponding to a centre of gravity of the light distribution. The optical axis 17 of light source 10 is close to that 8 of the camera 7, i.e. axes 17, 8 intersect under an small acute angle α, so that when light source 10 illuminates the strip 14 on surface 1, and there is a feature in the field of view 15 capable of casting a shadow, i.e. a projection or depression, the shadow will be hidden to the camera 7 by the feature itself. In contrast, with optical axes 8, 16 forming an angle β that is considerably larger than a, typically about 45°, a shadow cast in the light of light source 9 will be visible to the camera 7. Therefore, if the camera 7 takes an image of the surface portion illuminated by light source 10 and another illuminated by light source 9, and an image processor of controller 4 finds a dark portion in the former image but not in the latter, this dark portion can be assumed to be related to a three-dimensional structure on surface 1. If no such structure is present in the model of the workpiece 2 in storage 19, the controller 4 will conclude that the dark portion is due to a surface structure defect, will determine the position of the defect on the surface 1 and its size based on the known pose of the arm 3, on the size of the defect in the image and the known distance between the inspection assembly 5 and the surface 1, and will store these data for later use.

A structure defect in surface 1 might also appear brighter than its surroundings if it happens to be oriented so that it reflects light from one of the light sources 9, 10 to the camera 7. The likeliness that this will happen is the greater, than larger the angle is under which the defect can receive light from one of the sources 9, 10. This angle can be made large in one direction, e.g. the y direction, by light source 9 being elongate in this direction; in a second direction x it can be made large in the course of time by scanning the light source 9 in the second direction x, so that there is a high probability that while a defect is moving through the field of view of the camera 7 in the x direction, at some time it will be oriented so that it reflects light from light source 9 into the camera 7 and will thus be detected.

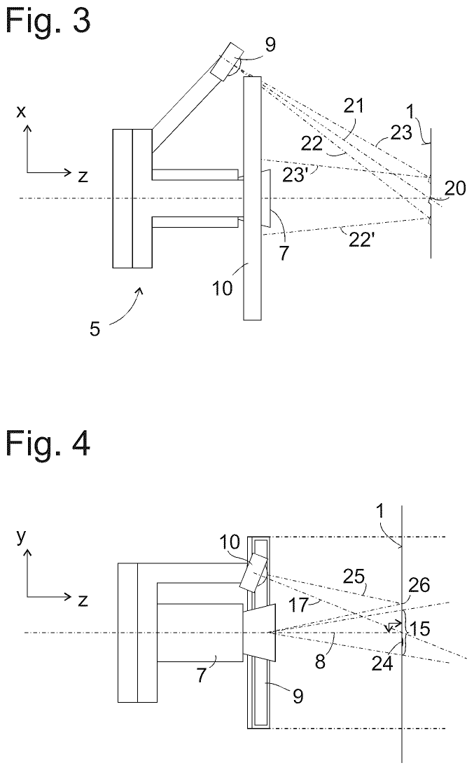

The controller 4 is programmed to move the inspection apparatus over the surface 1 in a scanning motion, so that every part of the surface that must be controlled for defects passes through the field of view of the camera 7. FIG. 3 illustrates such a scanning process: on the surface 1 there is a reflective defect 20. The inspection assembly 5, seen along the y direction, is performing a scanning movement in the x direction, in which light source 10 is elongate. The defect 20 is shown in solid lines in that instant of the scanning movement in which a light beam 21 from source 9 is mirrored by defect 20 towards the camera 7, and in an image taken by the camera 7, defect 20 will appear as a bright spot. In earlier and later instants of the scanning movement, beams 22, 23 from light source 9 will also be mirrored by defect 20, shown by dotted lines, but as the reflected beams 22′, 23′ fail to reach the lens of the camera 7, the defect 20 is not visible in an image. Light from light source 10 will reach the defect 20 under a different angle than beam 21, and will not be reflected into the camera 7, either. Since light source 10 extends in the scanning direction, a displacement of the inspection assembly 5 which is only a fraction of the length of the light source 10 can be expected to have a negligible effect on lighting conditions at the defect 11. Therefore, based on images from camera 7, controller 4 may decide that a given point of surface 1 is a structural defect when brightness of this point varies noticeably under light from source 10, or when the ratio of brightness under light from source 10 and brightness under light from source 9 varies while the point is moving through the field of view of the camera 7.

Another type of defect that can occur in the workpiece surface 1 is a stain 24 (cf. FIG. 4), i.e. a local variation of color that may be caused by a foreign object that adheres to the surface 1 or is embedded in it. The visibility of stain 24 to camera 7 should not vary substantially while the inspection assembly 5 is moving over the stain 24, and it should be similar in the light of both sources 9, 10, unless the camera 7 is blinded by light from source 9 or 10 reflected specularly into it or sees reflections of foreign objects on the surface 1.

The camera 7 can be prevented from seeing reflections of foreign objects by having its optical axis 8 oriented perpendicular to the surface 1; thus, if there is a specular reflection in the image seen by camera 7, it would be the reflection of its own front lens. Since the front lens is dark, its reflection will not conceal a stain.

Light source 10 is oriented so that its optical axis 17 intersects optical axis 8 on the surface 1, so that most of its light will be reflected away from camera 7, but still, there will be a light beam 25 from source 10 which is specularly reflected into camera 7. Blinding by this light 25 can be minimized if it doesn't reach a photodetector of the camera 7, i.e., if a point 26 on surface 1 where the light beam 25 is reflected is outside of the field of view 15 of the camera 7.

The controller 4 may decide that a given point of surface 1 is a stain if its brightness differs from that of points in its vicinity in a way for which no reason is apparent from the model of the workpiece 2 in storage 19, or from surface brightness data collected earlier from other workpieces of the same type, and if this difference is substantially constant while the point moves through the field of view of the camera.

While scanning the surface 1, controller 4 collects data on positions, size and type of defects encountered, and compares these to predetermined quality requirements. When these quality requirements aren't met, the controller 4 issues a warning message, so that workpiece 2 can be sent back to the paint workshop for touching up, accompanied by a record of the defects found by controller 4. Thus, it can be ensured that only those workpieces are touched up which could otherwise be rejected with cause by a customer. Moreover, the record output by controller 4 doesn't have to include all defects that were detected but can be limited to those that must be mended in order to meet the requirements, so that no time will be lost touching up defects that are actually insignificant.

In the embodiments of the present disclosure, a surface to be inspected can be located at an intersection of the optical axes of the first and second light sources, so that it can be illuminated by any of them. By operating the light sources by turns, the angle of incidence of light on a surface under inspection can be varied, and so can the luminosity distribution on the surface. For the variation to be distinctly detectable, the angle between the optical axes should not be less than 30°. The perspective of the camera, however, can remain the same, so that images obtained with one light source or the other can be compared straightforwardly, ideally on a pixel-by-pixel basis, without having to take account of variations of perspective. Since the apparatus doesn't have to be moved in order to gather images of a same surface region under different lighting conditions, such images can be obtained in a short time.

In order to facilitate detection of defects in the form of particles adhering to the finished surface, the angle between the optical axis of the camera and that of at least one of the light sources should not be too small, preferably not less than 30°, so that when the optical axis of the camera is aligned with the surface normal, a particle can cast a detectable shadow on the surface when illuminated by this light source. On the other hand, when the angle is too large, there is a possibility of the light source colliding with the surface under inspection, and unevenness of the surface may cause luminosity variations of the surface that may conceal a true defect. Therefore, the angle should not exceed 60°.

Emission ranges of the first and second light sources should overlap the field of view of the camera in a same plane, so that when a surface to be inspected is placed in that plane, the field of view of the camera can be illuminated by either light source.

One of the light sources might have its optical axis coincide with the optical axis of the camera, so that in its light, a particle on the surface would not cast any shadow at all, and a shadow that is visible in the light of the other light source only would be a clear indication of the presence of a particle.

On the other hand, it is not desirable to have a powerful reflection of one of the light sources reach the camera. Therefore, each light source should be offset from the optical axis of the camera far enough for a specular image of the light source to be located outside the field of view of the camera when the optical axis of the camera is normal to the surface to be inspected.

In order to maximize possible changes in brightness of the surface when switching between light sources, a first plane defined by the optical axes of the camera and the first light source is preferably substantially orthogonal to a plane defined by the optical axes of the camera and the second light source.

A surface defect can also be a local unevenness in an otherwise flat and reflecting surface. In manual inspection, such a defect will flash up when a worker turns an object to be inspected before his eyes, thereby varying both the direction of incidence of ambient light on the surface as well as the angle under which the surface is viewed. According to the invention a similar effect is achieved by at least the first light source being elongate in a direction perpendicular to its optical axis and the optical axis of the camera, thus being capable of illuminating a given surface point from various angles. The angle under which the surface point is viewed can then be varied by the camera being scanned along the surface.

When the scanning direction is parallel to the direction in which the light source is elongate, lighting conditions for the given surface point will practically not vary while at least a central portion of the first light source is passing by.

In order to ensure substantially invariable lighting conditions for the given surface point while it is within the field of view of the camera, the length of the light source in the direction perpendicular to its optical axis should greater than the width of the field of view of the camera in a plane in which the optical axes of the camera and the first light source intersect.

In order to reliably detect a reflective defect regardless of its orientation, the second light source may also be elongate in a direction perpendicular to its optical axis and the optical axis of the camera.

Preferably the light sources are LED. Since LEDs can toggle between on and off states at a high rate, these can be used to obtain alternating images illuminated by either the first or the second light source in a single scanning operation.

The actuator apparatus preferably comprises a robot arm carrying the camera and the light sources, and a controller for the robot arm. By means of the robot arm, the camera and the light sources can be scanned along a surface under inspection at a constant distance and/or under a constant viewing angle, even when the surface is not flat, and, if necessary, the viewing angle can be varied arbitrarily.

According to another aspect, the object of the invention is achieved by a method of surface inspection using the surface inspection apparatus as described above, the method comprising steps of a) placing part of a surface to be inspected at an intersection of optical axes of the camera and the light sources; b) thereafter obtaining a first image of the surface part illuminated by the first light source; c) switching off the first light source and switching on the second light source; d) thereafter obtaining a second image of the surface part illuminated by the second light source; e) thereafter deciding, based on a comparison of the first and second images, whether a feature observed in at least one of the images is indicative of a defect.

At least when a thus observed feature is found to be indicative of a defect, its size should be determined, in order to decide or to enable an operator to decide whether the feature should be touched up or not.

While the first and second light sources are being operated by turns the camera and the first and second light sources can be displaced continuously. When comparing images, the displacement can be compensated easily; by moving continuously, the time needed for an inspection can be reduced considerably.

When the direction of displacement is the direction in which the first light source is elongate, lighting conditions by the first light source will practically not change for a given surface point while it is passing through the field of view of the camera, so that any variation in luminosity of the surface point observed during the passage of the camera is likely to be due to reflection by a defect.

A preferred application of the disclosure is in the inspection of freshly painted surfaces.

The disclosure further describes a computer program product comprising instructions which, when executed by a processor, cause the processor to operate as the controller in the surface inspection apparatus described above.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A surface inspection apparatus comprising:
a) a camera;
b) an actuator apparatus for displacing the camera relative to a surface to be inspected;
c) a first light source mounted to the actuator apparatus for joint displacement with the camera; and
d) a second light source arranged so that an angle in which optical axes of the first and second light sources intersect is non-zero.

2. The surface inspection apparatus of claim 1, wherein an angle in which optical axes of at least one of the light sources and of the camera intersect is above 30° and/or below 60°.

3. The surface inspection apparatus of claim 1, wherein emission ranges of the first and second light sources overlap the field of view of the camera in a same plane.

4. The surface inspection apparatus of claim 1, wherein each light source is offset from the optical axis of the camera so that when the optical axis of the camera is normal to the surface to be inspected, a specular reflection of each light source on the surface is located out-side the field of view of the camera.

5. The surface inspection apparatus of claim 1, wherein a first plane defined by the optical axes of the camera and the first light source is substantially orthogonal to a plane defined by the optical axes of the camera and the second light source.

6. The surface inspection apparatus of claim 1, wherein at least the first light source is elongate in a direction perpendicular to its optical axis and the optical axis of the camera, optionally wherein the length of the light source in the direction perpendicular to the optical axes is greater than the distance between the light source and an intersection of the optical axes.

7. The surface inspection apparatus of claim 1, wherein at least one of the light sources comprises a LED.

8. The surface inspection apparatus of claim 1, wherein the actuator apparatus is adapted to operate the first and second light sources by turns.

9. The surface inspection apparatus of claim 1, wherein the actuator apparatus comprises a robot arm carrying the camera and the light sources, and a controller for the robot arm.

10. A method of surface inspection, comprising:
a) placing part of a surface to be inspected at an intersection of optical axes of a camera and first and second light sources;
b) thereafter obtaining a first image of the surface part illuminated by the first light source;
c) switching off the first light source and switching on the second light source;
d) thereafter obtaining a second image of the surface part illuminated by the second light source;
e) thereafter deciding, based on a comparison of the first and second images, whether a feature observed in at least one of the images is indicative of a defect.

11. The method of claim 10, further comprising the step of determining a size of the feature at least when the feature is found to be indicative of a defect.

12. The method of claim 10, wherein while the first and second light sources are being operated by turns, the camera and the first and second light sources are being displaced continuously.

13. The method of claim 10, wherein at least the first light source is elongate in a direction perpendicular to its optical axis, and wherein between instants in which the first and second images are taken, the camera and the light sources are displaced in the direction.

14. The method of claim 10, wherein the surface to be inspected is a freshly painted surface.
